(19) United States
(12) Patent Application Publication
(10) Pub. No.: US 2009/0015134 A1
(43) Pub. Date: Jan. 15, 2009

(54) HEAT DISSIPATION ARRANGEMENT OF A LIGHT EMITTING MODULE

(75) Inventor: Kai-Yu Lin, Chung-Ho City (TW)

Correspondence Address: KAI-YU LIN, P.O. BOX 108-00403, TAIPEI, TW

(73) Assignee: Kai-Yu Lin, Chung-Ho City (TW)

(21) Appl. No.: 12/172,268

(22) Filed: Jul. 13, 2008

(30) Foreign Application Priority Data
Jul. 13, 2007 (TW) 096125639

(51) Int. Cl. H01J 1/62

(52) U.S. Cl. 313/498

(57) ABSTRACT

A light emitting module includes a graphite base having a metal bearing surface at one side, a circuit board bonded to the metal bearing surface of the graphite base and having mounting through holes and a circuit layout, and light emitting devices each having a substrate carrying a light emitting chip and mounted in one mounting through hole of the circuit board and kept in contact with the metal bearing surface of the graphite base for transferring heat energy produced during light emitting operation to the graphite base for quick dissipation and two conducting legs electrically connected with the light emitting chip and respectively extended out of the substrate and electrically bonded to the circuit layout of the circuit board.

This application claims the priority benefit of Taiwan patent application number 096125639 filed on Jul. 13, 2007.

### BACKGROUND OF THE INVENTION

1. Field of the Invention

The present invention relates to a light emitting modules and more particularly, to a heat dissipation arrangement of a light emitting module that utilizes a graphite base for quick dissipation of heat from light emitting chips, preventing accumulation of waste heat in the light emitting devices.

2. Description of the Related Art

Following fast development of high technology, electronic devices are made having a small-sized or micro-sized characteristic, and the density per unit area is relatively increased to improve the performance. However, a high-performance or high-speed electronic device generates much waste heat during operation. If waste heat is not quickly dissipated during the operation of an electronic device, electron ionization and thermal stress will follow, lowering the stability and shortening the working life of the electronic device. Therefore, heat dissipation is a serious problem not to be overlooked.

Following the development of semiconductor and electronic packages toward a relatively higher power and higher density, the problem of heat dissipation becomes more critical. For dissipation of high density heat transfer, heat spreaders with embedded heat pipes are commonly used. However, this arrangement is not economic. Following increasing of density per unit area, heat diffusion speed must be relatively accelerated. However, every metal material has a heat transfer limit. The heat transfer coefficients of copper and aluminum are about 400 W/M-K and 200 W/M-K. These heat transfer rates cannot satisfy the demands for high power performance. Further, copper and aluminum have a high density (about 8.5 g/cc and 2.7 g/cc respectively). When an electronic device and a heat sink or heat spreader are joined together, the heavy weight of the heat sink or heat spreader may cause damage to the structure of the electronic device, shortening the service life of the electronic device.

In view of the drawback of a copper or aluminum based heat sink or heat spreader, new heat transfer materials are continuously created. Carbon is one of the most abundant substances in natural world. After graphitization treatment, carbon can be used electric conduction and heat transfer. Further, natural graphite is one of the allotropes of carbon. Natural graphite may exist in the form of crystalline flake graphite, i.e., flake graphite. When natrual graphite is processed into a thin film material, it has a in-plane heat transfer coefficient about 240 W/M-K˜600 W/M-K, however it has a low thru-thickness heat transfer coefficient about 6 W/M-K.

Further, natural graphite may be crushed and ground into nanometered powder for mixing with an adhesive for processing into raw graphie blocks by means of a seires of processing processed including compacting, cold compression, hot compression and vibration. The raw graphite blocks can then be dipped in a liquid asphaltic material and then processed through a heating process. The graphite blocks thus obtained have excellent thru-thickness heat conductivity practical. These high heat transfer coefficient graphite blocks can be used for making a base or substrate for electronic device for quick dissipation of waste heat.

### SUMMARY OF THE INVENTION

The present invention has been accomplished under the circumstances in view.

According to one aspect of the present invention, the light emitting module comprises a graphite base, which has a metal bearing surface at one side, a circuit board, which is bonded to the metal bearing surface of the graphite base and has mounting through holes cut through the top and bottom sides and a circuit layout arranged on the top side, and light emitting devices respectively mounted in the mounting through holes of the circuit board. Each light emitting device comprises a substrate mounted in one mounting through hole of the circuit board and kept in contact with the metal bearing surface of the graphite base, a light emitting chip mounted in the substrate, and two conducting legs electrically connected with the light emitting chip and respectively extended out of the substrate and electrically bonded to the circuit layout of the circuit board. During operation, produced heat energy is rapidly transferred from the light emitting chips of the light emitting devices to the graphite base for quick dissipation, thereby enhancing the light emitting performance of the light-emitting chips and prolonging their working life.

According to another aspect of the present invention, a heat sink is bonded to a metal bearing surface at the other side of the graphite base opposite to the circuit board. The heat sink is extruded from aluminum, copper, aluminum alloy or copper alloy, comprising a flat base panel bonded to the graphite base and a plurality of radiation fins perpendicularly extending from the flat base panel.

According to still another aspect of the present invention, the circuit board can be eliminated, and the circuit layout can be directly formed on the metal bearing surface of the graphite base by means of employing sputtering deposition, vacuum evaporation deposition, electroplating or non-electrolyte plating technique to coat the metal bearing surface with a layer of metal coating and then etching the metal coating subject to a predetermined pattern by means of a chemical etching technique. During deposition of the desired circuit layout, a dielectric material such as SiO₂, photoresist or polyimide resin is used to form an isolation layer on the metal bearing surface of the graphite base, defining the direction and shape of the formation of the circuit layout.

### BRIEF DESCRIPTION OF THE DRAWINGS

FIG. 1 is an elevational view of a part of a light emitting module according to a first embodiment of the present invention.

FIG. 2 is an exploded view of the light emitting module according to the first embodiment of the present invention.

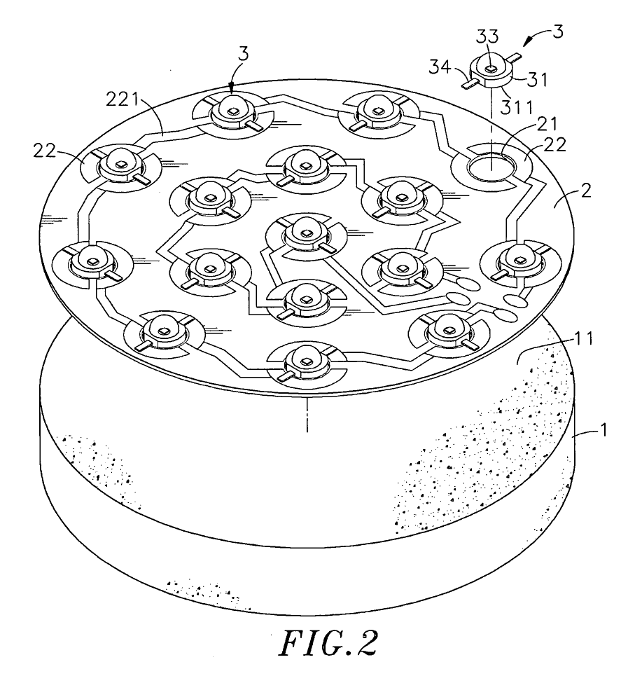

FIG. 3 is an exploded view in section in an enlarged scale of a part of the light emitting module according to the first embodiment of the present invention.

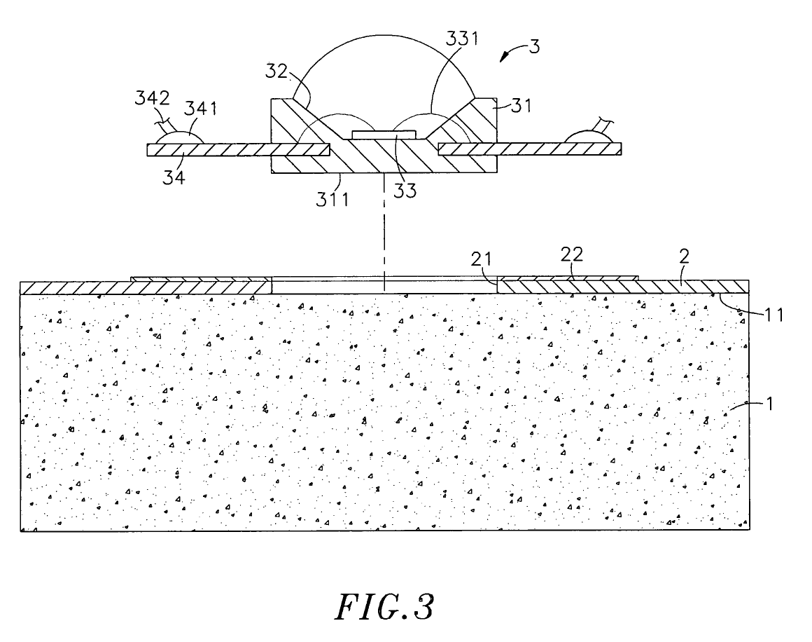

FIG. 4 is a sectional side view showing the assembly of FIG. 3 assembled.

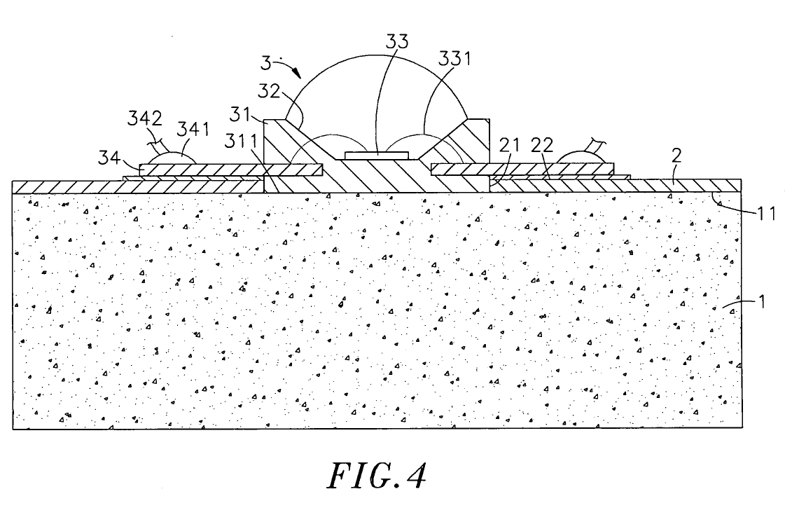

FIG. 5 corresponds to FIG. 4, showing a heat sink bonded to the metal bearing surface at the bottom side of the graphite base.

FIG. 6 is an exploded view of a light emitting module according to a second embodiment of the present invention.

FIG. 7 is an enlarged view of part A of FIG. 6.

### DETAILED DESCRIPTION OF THE PREFERRED EMBODIMENT

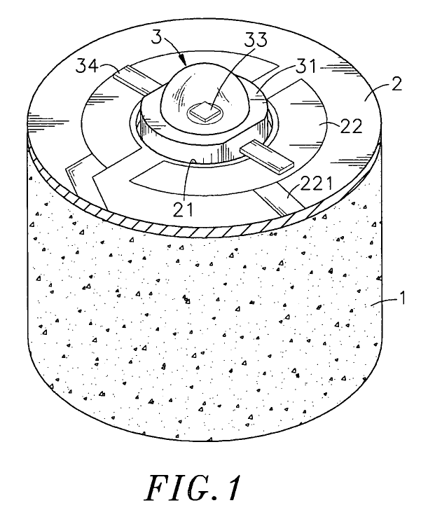

Referring to FIGS. 1˜4, a heat dissipation arrangement of a light emitting module in accordance with the present invention is shown comprising a graphite base 1, a circuit board 2, and light emitting devices 3.

The graphite base 1 is prepared from a high density graphite block having a thru-thickness heat transfer coefficient about 910 W/←K and a density around 1.2 g/cc˜2.2 g/cc. Further, the graphite base 1 has a metal bearing surface 11 respectively formed of copper, nickel or their alloy on top and bottom sides thereof by means of electroplating or vacuum deposition techniques for the purpose of heat dissipation.

The circuit board 2 has a predetermined number of mounting through holes 21 cut through the top and bottom walls, sets of electrode contacts 22 symmetrically arranged on the top wall at two sides around each mounting through hole 21, and conducting lines 221 arranged on the top wall and respectively connected between the sets of electrode contacts 22. Each set of electrode contacts 22 includes one for the negative pole and the other for the positive pole. Each conducting line 221 electrically connects the negative pole of the set of electrode contacts 22 around one mounting through hole 21 to the positive pole of the set of electrode contacts 22 around another mounting through hole 21.

Each light emitting device 3 comprises a substrate 31, which has a bottom contact surface 311 and a top receptacle 32 that prohibits outward diffusion of light source, a light-emitting chip 33 mounted in the top receptacle 32 of the substrate 31, two conducting legs 34 respectively outwardly extended from the substrate 31 at two opposite sides, and two lead wires 331 respectively electrically connected between the negative and positive terminals of the light-emitting chip 33 and the two conducting legs 34. Each conducting leg 34 has a soldering point 341 disposed at the top side outside the substrate 31 for the bonding of a power wire 342.

The light emitting devices 3 can be light emitting diodes, high power LEDs or laser diodes. During installation, the circuit board 2 is bonded to the metal bearing surface 11 at one side, namely, the top side of the graphite base 1 with a bonding agent, such as adhesive tape or adhesive resin. Thereafter, the light emitting devices 3 are respectively inserted into the mounting through holes 21 of the circuit board 2 to force the bottom contact surface 311 of each light emitting device 3 into contact with the metal bearing surface 11 at the top side of the graphite base 1 and to have the two conducting legs 34 of each light emitting device 3 be respectively bonded to the two electrode contacts 22 around each of the mounting through holes 21 of the circuit board 2 by means of surface mount technology. Alternatively, the conducting legs 34 can be bonded to respective via holes or the ball grip array on the circuit board 2. After installation, the positive and negative terminals of the light emitting devices 3 are respectively electrically connected together by means of the electrode contacts 22 and the conducting lines 221, and external power supply can then be transmitted through the light emitting devices 3 via the power wires 342.

When electric current is transmitted through the light-emitting chips 33 in the top receptacles 32 of the substrates 31 of the light emitting devices 3, the light-emitting chips 33 are activated to emit light. By means of the inwardly curved design of the top receptacle 32 of each light emitting device 3, the light emitted by the light-emitting chip 33 of each light emitting device 3 is concentrated, lowering the rate of loss of light and increasing the gain on reflection of light. During operation of the light emitting devices 3 of the light emitting devices 3, heat energy thus produced is transferred through the bottom contact surface 311 of each light emitting device 3 to the metal bearing surface 11 at the top side of the graphite base 1 for quick dissipation, preventing accumulation of heat energy in each light emitting device 3 and enhancing the light emitting performance of the light-emitting chips 33 and prolonging their working life.

Further, the number, location, size and shape of the mounting through hole 21 of the circuit board 2 are determined subject to the number and design of the light emitting devices 3, facilitating installation of the light emitting devices 3.

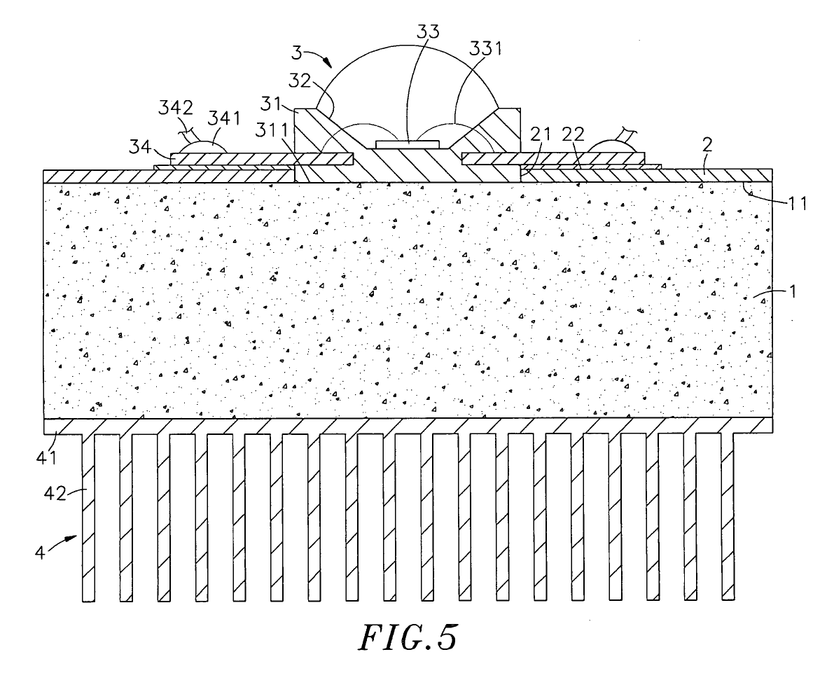

Referring to FIG. 5, a heat sink 4 may be bonded to the metal bearing surface 11 at the bottom side of the graphite base 1 opposite to the circuit board 2 that is bonded to the metal bearing surface 11 at the top side of the graphite base 1 for quick dissipation of heat. The heat sink 4 can be extruded from aluminum, copper, or their alloy, having a flat base panel 41 bonded to the metal bearing surface 11 at the bottom side of the graphite base 1 and a plurality of radiation fins 42 perpendicularly extending from the flat base panel 41. During operation of the light emitting devices 3 of the light emitting devices 3, heat energy thus produced is transferred through the bottom contact surface 311 of each light emitting device 3 to the heat sink 4 through the metal bearing surfaces 11 at the top and bottom sides and graphite structure of the graphite base 1, enabling heat energy to be quickly dissipated into the outside open air through the radiation fins 42.

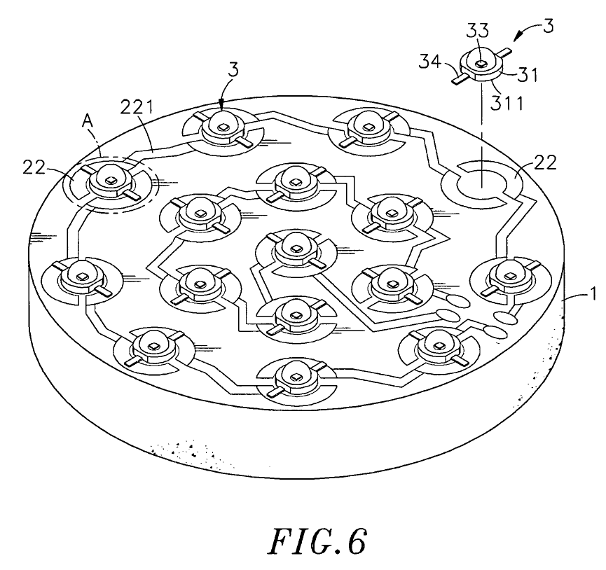

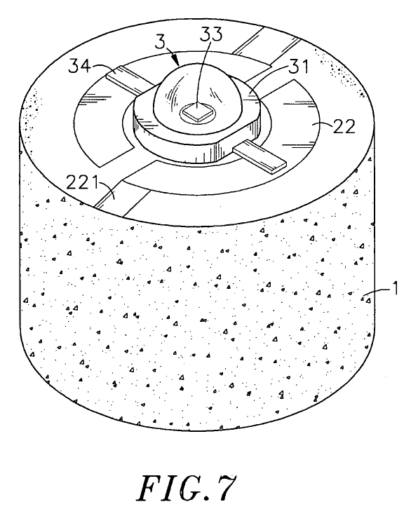

Referring to FIGS. 6 and 7 show a heat dissipation arrangement of light emitting module according to a second embodiment of the present invention. This second embodiment is substantially similar to the aforesaid first embodiment with the exception that this second embodiment eliminates the aforesaid circuit board 2 and has the sets of electrode contacts 22 and the conducting lines 221 directly formed on one metal bearing surface 11 of the graphite base 1 by means of employing sputtering deposition, vacuum evaporation deposition, electroplating or non-electrolyte plating technique to coat the metal bearing surface 11 with a layer of metal coating and then etching the metal coating subject to a predetermined pattern by means of a chemical etching technique. The metal material used can be selected from gold, copper, nickel, palladium, zinc or their alloys, or any metal material having excellent thermal conductivity.

During deposition of the aforesaid sets of electrode contacts 22 and the conducting lines 221, a dielectric material such as SiO₂, photoresist or polyimide resin is used to form an isolation layer on the metal bearing surface 11 of the graphite base 1, defining the direction and shape of the formation of the sets of electrode contacts 22 and the conducting lines 221. After formation of the sets of electrode contacts 22 and the conducting lines 221, the isolation layer is removed or maintained in position. Therefore, the desired circuit layout can be formed on the graphite base 1 directly without a circuit board. This second embodiment eliminates the aforesaid circuit board 2 and has the sets of electrode contacts 22 and the conducting lines 221 directly formed on one metal bearing surface 11 of the graphite base 1 for the mounting of the light emitting devices 3, facilitating the fabrication and effectively reducing the manufacturing cost.

In the aforesaid second embodiment, holes may be formed in the layer of metal coating on the metal bearing surface 11 of the graphite base 1 for accommodating the light emitting devices 3, allowing direct contact of the bottom contact surface 311 of each light emitting device 3 with the metal bearing surface 11 of the graphite base 1. During installation of the light emitting devices 3, the two conducting legs 34 of the light emitting devices 3 are respectively bonded to the respective sets of electrode contacts 22 by means of surface mount technology. During application of the light emitting module, the other metal bearing surface 11 of the graphite base 1 is bonded to the surface of an external device (such as the metal case of a machine or the base panel of a heat sink of a cooler module).

As stated above, the invention provides a heat dissipation arrangement of light emitting module, which has the following features and advantages:

1. Light emitting devices 3 are respectively mounted in the mounting through holes 21 of the circuit board 2 at the metal bearing surface 11 at one side of the graphite base 1 so that heat energy produced during operation of the light emitting chips 33 is rapidly transferred through the bottom contact surface 311 of each light emitting device 3 to the graphite base 1 for quick dissipation, enhancing the light emitting performance of the light-emitting chips 33 and prolonging their working life.

2. A heat sink 4 can be bonded to the other metal bearing surface 11 at one side of the graphite base 1 opposite to the circuit board 2 to dissipate heat transferred from the light-emitting chips 33 through the graphite base 1 into the outside open air rapidly. 3. The sets of electrode contacts 22 and the conducting lines 221 may be directly formed on one metal bearing surface 11 of the graphite base 1 for electric conduction, wire bonding or solder bond by means of deposition and chemical etching, facilitating the fabrication and improving the yield rate and reliability.

4. During deposition of the sets of electrode contacts 22 and the conducting lines 221, a dielectric material such as SiO₂, photoresist or polyimide resin is used to form an isolation layer on the metal bearing surface 11 of the graphite base 1, defining the direction and shape of the formation of the sets of electrode contacts 22 and the conducting lines 221, and therefore the desired circuit layout is formed on the graphite base 1 directly without a circuit board.

5. The light produced by each light emitting device 3 projects outwards through the smoothly arched outer surface of the top packaging resin of each light emitting device 3. By means of the inwardly curved design of the top receptacle 32 of each light emitting device 3, the light emitted by the light-emitting chip 33 of each light emitting device 3 is concentrated, lowering the rate of loss of light and increasing the gain on reflection of light.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A light emitting module, comprising:
a graphite base, said graphite base comprising a first metal bearing surface and a second metal bearing surface at two opposite sides thereof and a circuit layout on one said first metal bearing surface; and
at least one light emitting device mounted on said first metal bearing surface and electrically connected with said circuit layout, each said light emitting device comprising a substrate, said substrate having a bottom contact surface disposed in contact with said first metal bearing surface of said graphite base, a light emitting chip mounted in said substrate, and two conducting legs respectively extending from positive and negative poles of said light emitting chip and respectively electrically bonded to said circuit layout.

2. The light emitting module as claimed in claim 1, wherein said circuit layout is formed of a metal material selected from the group of gold, copper, nickel, palladium, zinc and their alloys on said first metal bearing surface of said graphite base by means of one of sputtering deposition, vacuum evaporation deposition, electroplating and non-electrolyte plating techniques subject to a predetermined pattern

3. The light emitting module as claimed in claim 1, wherein said circuit layout comprises multiple sets of electrode contacts, each set of electrode contacts comprising a negative pole electrode contact and a positive pole electrode contact, and a plurality of conducting lines respectively connecting the negative pole electrode contacts of said sets of electrode contacts and the positive pole electrode contacts of said sets of electrode contacts.

4. The light emitting module as claimed in claim 1, wherein the conducting legs of the light emitting chips of each said light emitting device are respectively bonded to said circuit layout by means of surface mount technology.

5. A light emitting module comprising:
a graphite base, said graphite base comprising a first metal bearing surface and a second metal bearing surface at two opposite sides thereof;
a circuit board mounted on said first metal bearing surface of said graphite base, said circuit board comprising at least one mounting through hole cut through top and bottom sides thereof and a circuit layout arranged on the top side of said circuit board opposite to said first metal bearing surface of said graphite base; and
at least one light emitting device respectively mounted in said at least one mounting through hole of said circuit board said and electrically connected with said circuit layout, each said light emitting device comprising a substrate, said substrate having a bottom contact surface disposed in contact with said first metal bearing surface of said graphite base, a light emitting chip mounted in said substrate, and two conducting legs respectively extending from positive and negative poles of said light emitting chip and respectively electrically bonded to said circuit layout.

6. The light emitting module as claimed in claim 5, wherein said first metal bearing surface of said graphite base is formed of a metal material selected from one of the group of copper, nickel, copper alloy and nickel alloy by means of one of electroplating and vacuum evaporation techniques.

7. The light emitting module as claimed in claim 5, wherein said circuit layout comprises multiple sets of electrode contacts, each set of electrode contacts comprising a negative pole electrode contact and a positive pole electrode contact, and a plurality of conducting lines respectively connecting the negative pole electrode contacts of said sets of electrode contacts and the positive pole electrode contacts of said sets of electrode contacts.

8. The light emitting module as claimed in claim 1, wherein the conducting legs of the light emitting chips of each said light emitting device are respectively bonded to said circuit layout by means of surface mount technology.

9. The light emitting module as claimed in claim 5, further comprising a heat sink bonded to said second metal bearing surface of said graphite base.

10. The light emitting module as claimed in claim 9, wherein heat sink comprises a flat base panel bonded to said second metal bearing surface of said graphite base and a plurality of radiation fins perpendicularly extending from one side of said flat base panel opposite to said second metal bearing surface of said graphite base.

11. The light emitting module as claimed in claim 5, wherein each said light emitting device is a light emitting diode.

12. The light emitting module as claimed in claim 5, wherein each said light emitting device is a high power light emitting diode.

13. The light emitting module as claimed in claim 5, wherein each said light emitting device is a laser diode.
